(19) United States
(12) Patent Application Publication
(10) Pub. No.: US 2022/0229695 A1
(43) Pub. Date: Jul. 21, 2022

(54) SYSTEM AND METHOD FOR SCHEDULING IN A COMPUTING SYSTEM

(71) Applicant: Core Scientific, Inc., Bellevue, WA (US)

(72) Inventors: Ian Ferreira, Issaquah, WA (US); Max Alt, San Francisco, CA (US)

(21) Appl. No.: 17/578,066

(22) Filed: Jan. 18, 2022

Related U.S. Application Data
(60) Provisional application No. 63/138,745, filed on Jan. 18, 2021.

(51) Int. Cl. G06F 9/48; G06F 9/50

(52) U.S. Cl. CPC G06F 9/4881; G06F 9/5027

(57) ABSTRACT

An improved multi-level scheduling system and method are disclosed. In one embodiment, the system comprises a coarse scheduler to allocate sets of computing resources at a first level and a set of fine grain schedulers configured to schedule at a second level, wherein the second level comprises individual computing resources within each set of computing resources. The fine grain scheduler may be configured to communicate with the coarse scheduler and monitor performance and utilization of the individual computing resources. The fine grain schedulers may also be configured to implement a different set of allocation rules than the coarse scheduler and request additional sets of resources from the coarse scheduler based on current and predicted utilization of the individual computing resources.

### CROSS-REFERENCE TO RELATED APPLICATION

This application claims the benefit of U.S. Provisional Patent Application Ser. No. 63/138,745, filed on Jan. 18, 2021, the disclosure of which is hereby incorporated by reference in its entirety as though fully set forth herein.

### TECHNICAL FIELD

The present disclosure generally relates to systems and method for scheduling in computing systems.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Distributed computing environments have long used schedulers to allocate resources (e.g., physical or virtual CPUs) across multiple tasks that are executed concurrently. More recently, many distributed computing environments have moved to using containers to package and isolate these concurrent tasks. For example, Docker containers/pods that are orchestrated by Kubernetes is one popular solution.

Many data scientists desire to run their GPU-based inference tasks in containers in such an environment. To increase GPU utilization, there has been a desire to schedule some of these concurrent tasks on the same GPU device, effectively sharing the GPU across different containers or pods. There are now solutions to enable this based on scheduler extenders and device plugin mechanisms. While these scheduler extenders permit resource sharing across different containers or pods, there is no current mechanism available for automatic intelligent multi-level scheduling in distributed containerized environments. For these reasons improved systems and methods for multi-level scheduling in containerized environments are desired.

The foregoing discussion is intended only to illustrate examples of the present field and is not a disavowal of scope.

### SUMMARY

An improved multi-level scheduling system and method are contemplated. In one embodiment, the system comprises a coarse scheduler for scheduling at the cluster/pod, a set of one or more containers for and a set of fine grain schedulers configured within each container configured to schedule at the process level. This hierarchical o multi-level coarse and fine-grained scheduling system and method may be particularly helpful to improve performance in systems where a very large number of small tasks need to be performed and can be performed in parallel. For example, an application requiring 10,000 processes to be performed in parallel could be scheduled with a coarse scheduler performing 500 coarse allocations (e.g., 500 containers each with a fine grain scheduler that in turn allocates 200 tasks/threads). A traditional single-level scheduler scheduling this application with 10,000 pods or containers would have significantly more overhead.

In one embodiment, the method may comprise prompting a user to specify an application to be run, a data source to be processed by the application, and a location for the application to store results. In response, a coarse scheduler may be configured to allocate resources (e.g., CPUs and or GPUs) at the container level. One or more containers for the application may be created, with each container having a fine grain scheduler configured to schedule in-container processes. The fine grain scheduler may be configured to communicate with the coarse scheduler and may be configured to implement a different set of allocation rules than the coarse scheduler.

The method may also comprise creating a set of one or more pods for the application, where each container is contained within one of the pods, and the coarse scheduler may be configured to share computing system resources between pods. In response to receiving an application to execute, a plurality of coarse host processes may be created. The coarse schedulers may be configured based on historical performance data collected from prior runs of the application. The fine grain scheduler may be configured based on historical performance data collected from prior runs of the application.

The method may be implemented for example using software instructions stored on a non-transitory, computer-readable storage medium (e.g., disk or flash). The instructions are executable by a processor of a computational device to operate a coarse-grained scheduler configured to allocate coarse blocks of resources to portions of an application that is to be executed; and operate a fine-grained scheduler configured to (i) allocate tasks to queues, (ii) assign nodes to the queues with tasks, and (iii) monitor the queue length and resource utilization of the allocated nodes, wherein if the queue length or allocated resource utilization are above a first predetermined threshold, the fine-grained scheduler is configured to allocate additional resources from the coarse-grained scheduler.

The fine-grained scheduler may be further configured to request additional coarse blocks of resources if available resources fall below a second predetermined threshold. It may also apply a resource allocation policy based on resource availably and capabilities.

In some embodiments, the fine-grained scheduler may apply a resource allocation policy based on resource availably and capabilities, and it may also apply a resource allocation policy further based on per description or historical/prediction data.

A method for scheduling tasks in a computing system is also contemplated. In one embodiment, the method may comprise allocating coarse blocks of resources to portions of an application that is to be executed, allocating tasks to queues, assigning nodes to the queues with tasks, and monitoring the queue length and resource utilization of the allocated nodes. If the queue length or allocated resource utilization are above a first predetermined threshold, additional resources from the coarse-grained scheduler may be allocated.

The method may further comprise requesting additional coarse blocks of resources if available resources fall below a second predetermined threshold. In some embodiments, the method may further comprise monitoring utilization levels, predicting when additional coarse blocks of resources may be needed, and performing said requesting in response thereto. The predictions of when additional coarse blocks of resources may be needed may be made based on current and historical utilization levels.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a diagram generally illustrating an example of a distributed computing system according to teachings of the present disclosure.

FIG. 2 is a diagram generally illustrating an example of a traditional system for scheduling applications in a computing system according to teachings of the present disclosure.

FIG. 3 is a diagram generally illustrating an example of a multi-level system for scheduling applications in a computing system according to teachings of the present disclosure.

FIG. 4 is another diagram generally illustrating an example of a method for scheduling applications in a computing system according to teachings of the present disclosure.

FIG. 5 is a flow chart generally illustrating an example of a method for scheduling applications in a computing system according to teachings of the present disclosure.

FIG. 6 is a flow chart generally illustrating an example of a method for scheduling applications in a computing system according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, they do not limit the present disclosure to these embodiments and/or examples. On the contrary, the present disclosure covers alternatives, modifications, and equivalents.

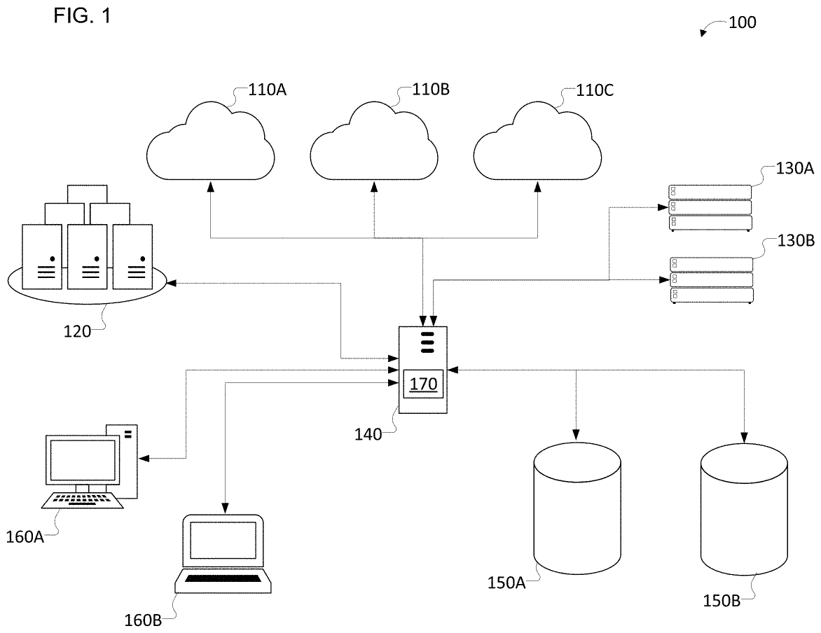

Turning now to FIG. 1, an example of a distributed computing system 100 is shown. In this example, the distributed computing system 100 is managed by a management server 140, which may for example provide access to the distributed computing system 100 by providing a platform as a service (PAAS), infrastructure as a service (IAAS), or software as a service (SAAS) to users. Users may access these PAAS/IAAS/SAAS services from their on-premises network-connected PCs, workstations, or servers (160A) and laptop or mobile devices (160B) via a web interface.

Management server 140 is connected to a number of different computing devices via local or wide area network connections. This may include, for example, cloud computing providers 110A, 110B, and 110C. These cloud computing providers may provide access to large numbers of computing devices (often virtualized) with different configurations. For example, systems with a one or more virtual CPUs may be offered in standard configurations with predetermined amounts of accompanying memory and storage. In addition to cloud computing providers 110A, 110B, and 110C, management server 140 may also be configured to communicate with bare metal computing devices 130A and 130B (e.g., non-virtualized servers), as well as a datacenter 120 including for example one or more supercomputers or high-performance computing (HPC) systems (e.g., each having multiple nodes organized into clusters, with each node having multiple processors and memory), and storage systems 150A and 150B. Bare metal computing devices 130A and 130B may for example include workstations or servers optimized for machine learning computations and may be configured with multiple CPUs and GPUs and large amounts of memory. Storage systems 150A and 150B may include storage that is local to management server 140 and well as remotely located storage accessible through a network such as the internet. Storage systems 150A and 150B may comprise storage servers and network-attached storage systems with non-volatile memory (e.g., flash storage), hard disks, and even tape storage.

Management server 140 is configured to run a distributed computing management application 170 that receives jobs and manages the allocation of resources from distributed computing system 100 to run them. Management application 170 is preferably implemented in software (e.g., instructions stored on a non-volatile storage medium such as a hard disk, flash drive, or DVD-ROM), but hardware implementations are possible. Software implementations of management application 170 may be written in one or more programming languages or combinations thereof, including low-level or high-level languages. The program code may execute entirely on the server 140, partly on server 140 and partly on other computing devices in distributed computing system 100.

The management application 170 may be configured to provide an interface to users (e.g., via a web application, portal, API server or command line interface) that permits users and administrators to submit applications/jobs via their user devices/workstations 160A and laptops or mobile devices 160B, designate the data sources to be used by the application, designate a destination for the results of the application, and set one or more application requirements (e.g., parameters such as how many processors to use, how much memory to use, cost limits, application priority, etc.). The interface may also permit the user to select one or more system configurations to be used to run the application. This may include selecting a particular bare metal or cloud configuration (e.g., use cloud A with 24 processors and 512 GB of RAM).

Management server 140 may be a traditional PC or server, a specialized appliance, one or more nodes within a cluster (e.g., running with a virtual machine or container). Management server 140 may be configured with one or more processors (physical or virtual), volatile memory, and non-volatile memory such as flash storage or internal or external hard disk (e.g., network attached storage accessible to server 140).

Management application 170 may also be configured to receive computing jobs from user devices/workstations 160A and 160B, determine which of the distributed computing system 100 computing resources are available to complete those jobs, make recommendations on which available resources best meet the user's requirements, allocate resources to each job, and then bind and dispatch the job to those allocated resources. In one embodiment, the jobs may be configured to run within containers (e.g., Kubernetes with Docker containers, or Singularity) or virtualized machines on the distributed computing system 100. Kubernetes is an open-source system for automating deployment, scaling, and management of containerized applications. Singularity is a container platform popular for high performance workloads such as artificial intelligence, machine/deep learning.

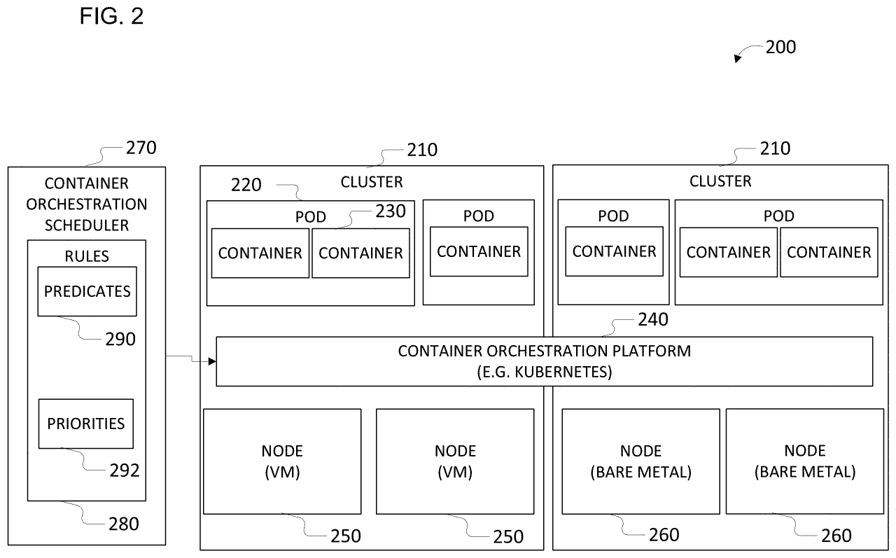

Turning now to FIG. 2, a diagram generally illustrating a traditional system 200 for scheduling applications in a distributed computing system (e.g., such as the one described above in connection with FIG. 1.), according to teachings of the present disclosure is shown. In this embodiment, the system comprises one or more clusters 210. Each cluster is capable of executing multiple pods 220, and each pod 220 is capable of executing one or more containers 230. The containers are managed by a container orchestration platform 240 (such as Kubernetes) which allocates resources from one or more nodes (e.g., virtualized nodes 250 or bare metal nodes 260). The container orchestration platform 240 may be controlled by a container orchestration scheduler 270 (e.g., Kubernetes scheduler or Slurm). Slurm is open-source job scheduling system used by many high-performance clusters. The container orchestration scheduler 270 may have a set of rules 280 including predicates 290 and priorities 292 that guide how it schedules tasks and allocations resources from nodes to containers. Example predicates may include checking if requested resources are free (e.g., network ports, storage size), and example priorities may include affinity (e.g., a preference to schedule pods together such as in same cluster).

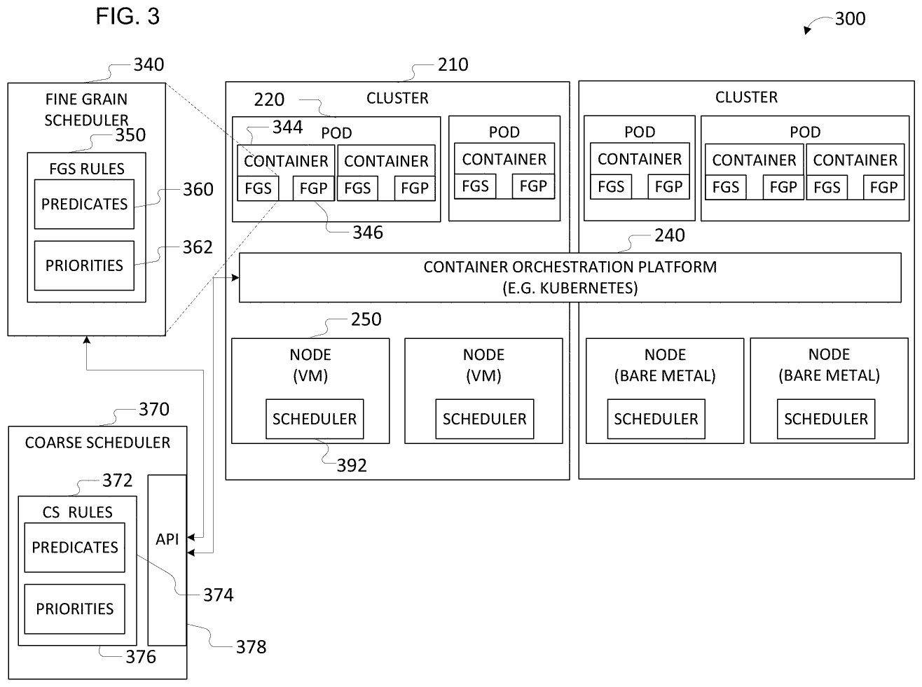

Turning now to FIG. 3, a diagram generally illustrating an example multi-level system 300 for scheduling applications in a computing system according to teachings of the present disclosure is shown. In this embodiment, there are multiple levels of schedulers. The container orchestration platform 240 is scheduled by a coarse scheduler 370, that has its own coarse scheduling rules 372, coarse scheduling predicates 374, and coarse scheduling priorities 376. Coarse scheduler 370 may also have an application programming interface (API) 378 that the container orchestration platform 240 and fine grain schedulers 340 use for communication.

Coarse scheduler 370 may be configured to allocate and schedule resources at a coarse level (e.g. at a node level within the distributed computing system). In this embodiment, each container 346 may have its own fine grain scheduler 340 with its own fine grain scheduling rules 350, fine grain scheduling predicates 360 and fine grain scheduling priorities 362. Each container may execute multiple fine grain processes 344, e.g., using queues that are allocated resources by the fine grain schedulers 340. For example, one fine grain scheduler 340 may create four queues and schedule multiple fine grain tasks to each queue. When additional resources are required, the fine grain scheduler 340 may request additional resources from the coarse scheduler 370 via the course scheduler API 378. The coarse scheduler 370 may allocate resources in sets or chunks (e.g. on a per node basis), while the fine grain scheduler may allocate resources on a second, higher resolution base (e.g., on a per CPU/GPU basis or per fine grain process or task basis).

Note that additional levels in the scheduler hierarchy are also possible and contemplated. For example, each node may have its own scheduler 392 (e.g., an operating system scheduler) as well. In some embodiments, performance is monitored (e.g., with each container). In other embodiments virtual machines, hypervisors, or other types of abstraction may be used in addition to or in place of containers.

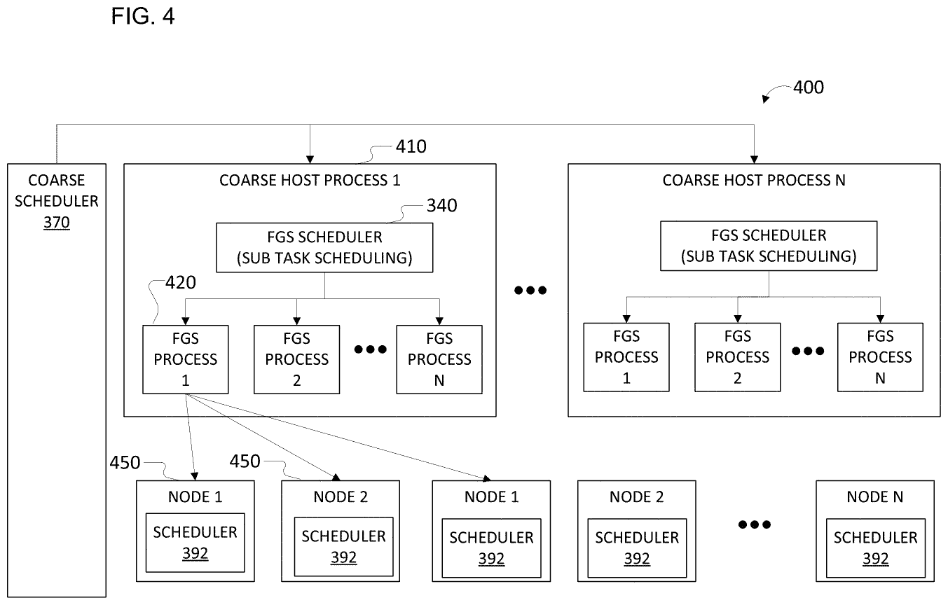

Turning now to FIG. 4, a diagram generally illustrating an example system 400 for scheduling applications in a computing system according to teachings of the present disclosure is shown. In this example embodiment, containers and virtual machines are not used. Instead, fine grain scheduler 340 communicates with coarse scheduler 370 and performs sub-task scheduling by allocating fine grain scheduled processes 420 to computing system nodes 450 directly. Sub-tasks assigned to each node are then scheduled and executed on the node's processor(s) by the node's scheduler 392.

For each new coarse process 410 created by coarse scheduler 370, a fine grain scheduler 340 is created. Fine grain scheduler 340 then spawns multiple fine grain processes 420 and selects an optimal node from the set of available nodes 450 for them to run on. This may for example be based on specified requirements of the task (e.g., a vector compute task needing a GPU). Nodes meeting those requirements may be evaluated using one or more fine grain scheduler priorities, and the one with the best match (e.g. highest score) may be picked.

Some examples of factors that may be taken into account for scheduling decisions include factors such as specific resource requirements, policy constraints, affinity, data locality, available interconnection bandwidth. In some embodiments the fine grain scheduler may maintain queues. For example, when all available nodes are busy, processes are queued until a suitable node becomes available.

In some embodiments, the coarse and or fine grain schedulers may be configured to monitor and store performance data for processes for different applications. This database of historical performance data may then be used by the coarse and fine grain schedulers to make intelligent predictions for scheduling and resource application. These predictions may supplement the existing rules/priorities configured in the coarse and fine-grain schedulers.

In some embodiments, the coarse scheduler may allocate coarse blocks of resources to portions of an application that is to be executed, and the fine grain scheduler may allocate tasks to queues and assign nodes to the queues with tasks. The monitoring may for example include tracking the queue length and resource utilization of the allocated nodes. If the queue length or allocated resource utilization percentage is outside a desired threshold (e.g., either predetermined or as informed by a prediction engine based on historical training data), the fine grain scheduler may request additional resources from the coarse scheduler or release resources back (so they are available again to the coarse scheduler). In this way, the fine grain scheduler may for example predict when additional coarse blocks of resources may be needed based on current and historical utilization levels and make requests ahead of time accordingly.

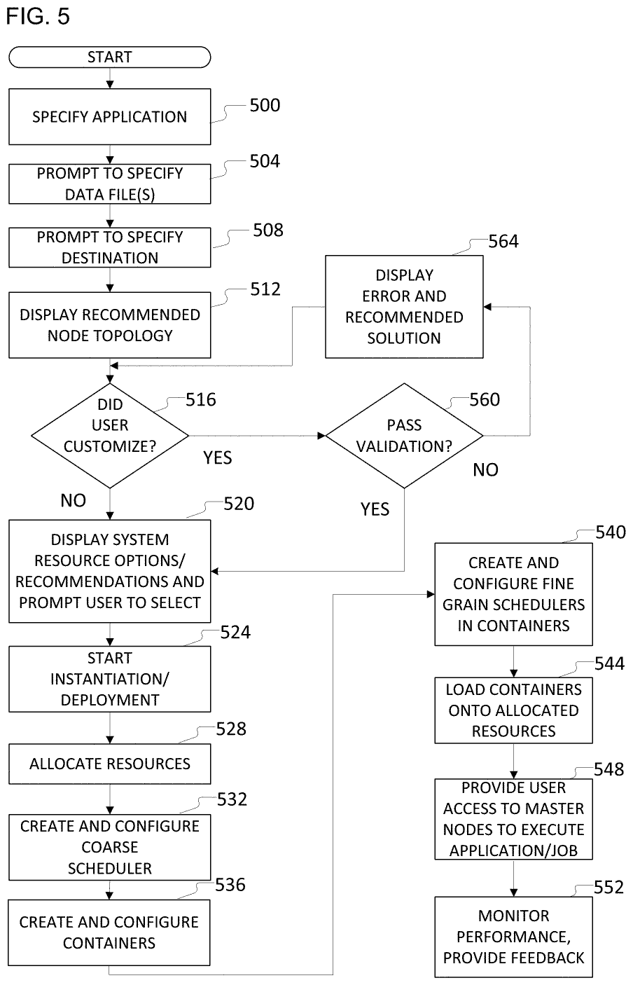

Turning now to FIG. 5, a flow chart generally illustrating an example of a method for scheduling applications in a computing system according to teachings of the present disclosure is shown. A user is prompted to specify an application (step 500), and any associated options such as data files and destinations for results. For example, a user might specify Jupyter (an open-source, interactive web tool known as a computational notebook used for data science) as the application that they are using. There may be multiple options for a particular application. For example, an application (e.g., a Jupyter notebook) can be run in multiple modes, such as interactive or batch mode. Along with the application, the user may be prompted to specify one or more data files to be used with the application (step 504). For example, a machine learning application that a data scientist has written might require training data sets or production data to be processed. Some applications may also have options to specify an output location where the resulting data is to be stored (step 508).

Based on the information input by the user, a recommended logical node or cluster topology is displayed (step 512). A logical topology is a high-level definition of how many processing nodes (e.g., master nodes and worker nodes) will be used and what in what hierarchy they are connected and to what resources (e.g., memory, network, storage) they are connected to. The recommendation may, for example, be based on known requirements for the particular application selected (e.g., information stored when the application was entered into the application catalog). The recommendation may also be based on other information provided by the user (e.g., the size of the data file to be processed, the location of the data file to be processed, whether the application will be run in interactive mode or batch mode, etc.). Customer-specific business rules (e.g., geography-based restrictions or compute provider-based restrictions) may also be specified by the user and/or system administrator and applied.

The user may be given the opportunity to modify the recommended node topology (step 516). If the user modifies the topology, the system may perform a validation check on the changes (step 560), and display error messages and recommended solutions (step 564). For example, if the user overrides a recommended topology of one master node having four worker nodes to delete the master node, an error message may be displayed that each worker node requires a master node. Similarly, if the user configures too many worker nodes for a single master node (e.g., exceeding a known limitation for a particular application), an error message may be displayed along with a recommendation for how many additional master nodes are required.

If no changes are made by the user, or if the user's changes pass validation, system resource options (including indicators of which ones are recommended) may be displayed, and the user may be prompted to select the option that will be used to run the job (step 520). These system resources options may for example include a list of bare metal systems and cloud providers with instance options capable of executing the user's application with the logical topology specified. The determination of which resources to offer may be based on a set of computing resource configuration files that include the different options for each of the bare metal and cloud computing systems. For example, the configuration options for a particular cloud computing provider may include a list of all possible system configurations and their corresponding prices. In addition to pricing, it may also include relative performance information (e.g., based on relative execution times for one or more test jobs executed on each cloud system configuration). The system resource options and recommendations may be determined by comparing the application information provided by the user (e.g., application, data file size and location. etc.).

Estimated compute times (e.g., based on the test job most similar to the user's application) and projected costs may also be presented to the user along with system resource options. For example, the options may be presented sortable based on estimated cost or estimated time to job completion. The options may also be sortable based on best fit to the user's specified application and logical topology.

Once the user makes their selection, application instantiation and deployment may be started (step 524). The specific resources to be used may be allocated (e.g., processors, storage, and memory may be reserved) (step 528). A coarse scheduler may be instantiated, e.g., if one is not already running on the system and configured (step 532). The coarse grain scheduler may for example be configured with access to some or all of the computing resources in the distributed computing system. Other configuration data may for example include a minimum size of coarse resource allocation (e.g., minimum number of nodes allocated per pod). Containers and or virtual machines for the application(s) being run may also be automatically created (e.g., for instances not running on bare metal) (step 536). This may for example include creation of master node containers and worker node containers that are configured to communicate with each other. As noted above, the topology may be based on the particular application the user specified. The containers and virtual machines may include all necessary settings for the application to run, including configurations for ssh connectivity, IP addresses, connectivity to the other appropriate containers, virtual machines or bare metal nodes (e.g., connected master and worker nodes), etc. A fine grain scheduler may also be created and configured in each container, virtual machines, or bare metal node (step 540). The containers may then be automatically loaded onto the appropriate allocated resources (step 544), and the user may be provided access (e.g., to a master node) in order to start the application (step 548), e.g., for non-batch mode instances. Once the application is running, performance may be monitored (step 552), and feedback may be provided to the user.

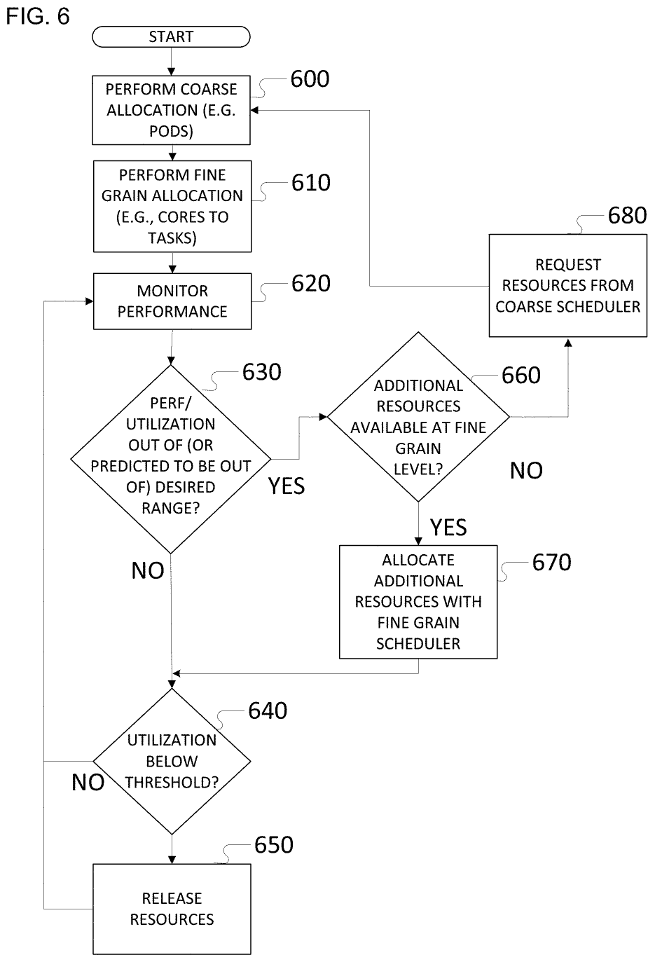

Turning now to FIG. 6, is a flow chart generally illustrating another example embodiment of a method for scheduling applications in a computing system according to teachings of the present disclosure is shown. Coarse allocation may be performed (step 600) at a first or coarse level or resolution. For example, resources from the distributed computing system may be allocated according to a pre-specified granularity (e.g., a single node, a 2 CPU/8GPU set). These resources may be assigned to a first or coarse portion of an application, e.g., a pod with a master application node, a pod with a worker application node, a Horovod training node in a machine learning application (Horovod is a popular distributed deep learning training framework).

Fine grain allocation may be performed (step 610) at a second finer level (e.g., higher resolution). For example, with a pod having two containers, each container or virtual machine may have its own fine grain scheduler that allocates portions of CPUs/GPUs, memory, storage, network bandwidth, etc., to portions of applications (e.g., individual jobs, tasks, or processes) from the set of coarsely resources that have been allocated to the particular container or virtual machine. This fine grain allocation may for example comprise creating a set of queues for each resource and the assigning tasks to the queues. The fine grain scheduler may assign tasks to queues based on the requirements of the task (e.g., task benefiting from GPU would be assigned to a queue with one or more GPUs allocated to the core).

Performance of the system may be monitored (step 620). For example, queue depth, wait times, and utilization rates may be monitored. If the performance determined to be outside a desired range or is predicted to be outside the desired range in the near future (step 630), the fine grain scheduler may be configured to determine if additional resources are available (e.g., resources that have been allocated at the coarse level to the pod or container). If additional resources are available (step 660), the fine grain scheduler may allocate those (step 670). For example, if a particular queue has many tasks queued up, additional CPUs/GPUs may be allocated the to queue, or a new queue may be created and allocated additional CPUs/GPUs. If additional allocated resources are not available, the fine grain scheduler may be configured to request additional (coarsely allocated) resources from the coarse scheduler (step 680).

If resource utilization within the pod or container falls below a predetermined threshold (step 640), the fine grain scheduler may be configured to release resources back to the coarse scheduler (step 650). In some embodiments, the resources may be released in sets or batches that meet the coarse scheduler's minimum allocation.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a computer/computing device, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A method for scheduling tasks in a computing system, the method comprising:
prompting a user to specify an application to be run;
prompting the user to specify a data source to be processed by the application;
prompting the user to specify a location for the application to store results;
creating a coarse scheduler configured to allocate container level resources; and
creating one or more containers for the application, wherein each container comprises a fine grain scheduler configured to schedule in-container processes.

2. The method of claim 1, wherein the fine grain scheduler is configured to communicate with the coarse scheduler.

3. The method of claim 1, wherein the fine grain scheduler is configured to implement a different set of allocation rules than the coarse scheduler.

4. The method of claim 1, further comprising creating a set of one or more pods for the application, wherein each of the containers is contained within one of the pods.

5. The method of claim 1, wherein the coarse scheduler is configured to share computing system resources between pods.

6. The method of claim 5, wherein the computing system resources comprise CPUs and GPUs.

7. The method of claim 1, wherein the coarse scheduler is configured based on historical performance data collected from prior runs of the application.

8. The method of claim 1, wherein the fine grain scheduler is configured based on historical performance data collected from prior runs of the application.

9. The method of claim 1, further comprising creating a plurality of coarse host processes and a plurality of fine grain processes.

10. A non-transitory, computer-readable storage medium storing instructions executable by a processor of a computational device, which when executed cause the computational device to:
operate a coarse scheduler configured to allocate coarse blocks of resources to portions of an application that is to be executed; and
operate a fine-grained scheduler configured to (i) allocate tasks to queues, (ii) assign nodes to the queues with tasks, and (iii) monitor queue length and resource utilization of the assigned nodes, wherein if the queue length or resource utilization are above a first predetermined threshold, the fine-grained scheduler is configured to request additional resources from the coarse scheduler.

11. The non-transitory, computer-readable storage medium of claim 10, wherein the fine-grained scheduler is further configured to request additional coarse blocks of resources if available resources fall below a second predetermined threshold.

12. The non-transitory, computer-readable storage medium of claim 10, wherein the fine-grained scheduler is further configured to applies a resource allocation policy based on resource availability and capabilities.

13. The non-transitory, computer-readable storage medium of claim 10, wherein the fine-grained scheduler applies a resource allocation policy based on resource availably and capabilities.

14. The non-transitory, computer-readable storage medium of claim 10, wherein the fine-grained scheduler applies a resource allocation policy further based on per description or historical/prediction data.

15. A method for scheduling tasks in a computing system, the method comprising:
allocating coarse blocks of resources to portions of an application that is to be executed;
allocating tasks to queues;
assigning nodes to the queues with allocated tasks; and
monitoring queue length and resource utilization of the assigned nodes, wherein if the queue length or allocated resource utilization are above a first predetermined threshold, allocating additional resources from a coarse scheduler.

16. The method of claim 15, further comprising requesting additional coarse blocks of resources if available resources fall below a second predetermined threshold.

17. The method of claim 16, further comprising:
predicting when additional coarse blocks of resources may be needed; and
performing said requesting in response thereto.

18. The method of claim 16, further comprising monitoring utilization levels.

19. The method of claim 18, further comprising:
predicting when additional coarse blocks of resources may be needed based on current and historical utilization levels; and
performing said requesting in response thereto.
